(19) United States
(12) Patent Application Publication
(10) Pub. No.: US 2009/0146982 A1
(43) Pub. Date: Jun. 11, 2009

(54) Lighting Calibration System and Method

(76) Inventors: Jeff Thielman, Corvallis, OR (US); Will Allen, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/203,690

(22) Filed: Sep. 3, 2008

Related U.S. Application Data
(60) Provisional application No. 60/992,414, filed on Dec. 5, 2007.

(51) Int. Cl. G09G 5/00

(52) U.S. Cl. 345/207

(57) ABSTRACT

A lighting calibration system for a video display environment includes a video display and a lighting sensor, fixedly positioned in the environment, and a lighting detection system, coupled to the lighting sensor and controllable from outside the environment. The lighting detection system is configured to receive positionally and temporally unique signals from the lighting sensor, and to provide an indication when lighting conditions in the environment differ from a selected lighting standard, based upon the signals.

### CROSS-REFERENCE TO RELATED APPLICATIONS

This Application claims the benefit of U.S. Provisional patent application Ser. No. 60/992,414, filed Dec. 5, 2007, which is hereby incorporated by reference in it's entirety.

### BACKGROUND

The present disclosure relates generally to the calibration of lighting in a video display environment. One type of video display environment in which lighting calibration is a consideration is a video conference room. Video conference systems that use specially-configured video conference rooms or studios have been developed to provide the look and feel of a face-to-face conference. Such systems can include a pair (or more) of specially-configured video conference studios that each include seating places for multiple persons facing one or more video conference displays. One or more video conference cameras take images of the persons in each room, and provide the respective images to corresponding video displays in the other video conference studios, wherever they are located.

In this type of video conference arrangement, the participants can see and hear the other participants as if they were all together in the same room. These types of video conference systems are sometimes referred to as “remote presence” or “telepresence” video conference systems. With the video conference cameras properly oriented and a suitable background in each conference room, this configuration can provide a blended video conference environment that approximates the appearance of a face-to-face conference session.

One aspect that contributes to the quality of experience of a remote presence video conference system is the lighting in the room. In a video conference environment, changes in lighting can affect how the conference is perceived. There are a number of lighting changes that can affect a conference, including reduced light, increased light, lighting color shifts, and inconsistent lighting. The lighting in a video conference studio can be calibrated at initial installation or during followup service. However, this generally involves a technician physically travelling to the site to check light levels and make repairs or changes if necessary. This can be expensive and time consuming.

### BRIEF DESCRIPTION OF THE DRAWINGS

Various features and advantages of the present disclosure will be apparent from the detailed description which follows, taken in conjunction with the accompanying drawings, which together illustrate, by way of example, features of the present disclosure, and wherein:

FIG. 1 is a plan view of one embodiment of a video conference room incorporating lighting calibration sensors;

FIG. 2 is a perspective view looking toward the front of the video conference room of FIG. 1, showing the array of video displays and the conference table;

FIG. 3 is a cross-sectional or elevation view of one embodiment of a video conference room like that of FIG. 1 having an integrated lighting calibration system;

FIG. 4 is a plan view of another embodiment of a video conference room incorporating a single lighting calibration sensor for detecting a light color change;

FIG. 5 is a plan view of another embodiment of a video conference room incorporating lighting calibration sensors for detecting a change in ambient lighting;

FIG. 6A is a plan view of another embodiment of a video conference room incorporating a single overhead lighting sensor;

FIG. 6B is a side view of the video conference room of FIG. 6A; and

FIG. 7 is a flowchart outlining the steps involved in one method of lighting calibration in accordance with the present disclosure.

### DETAILED DESCRIPTION

Reference will now be made to exemplary embodiments illustrated in the drawings, and specific language will be used herein to describe the same. It will nevertheless be understood that no limitation of the scope of the present disclosure is thereby intended. Alterations and further modifications of the features illustrated herein, and additional applications of the principles illustrated herein, which would occur to one skilled in the relevant art and having possession of this disclosure, are to be considered within the scope of this disclosure.

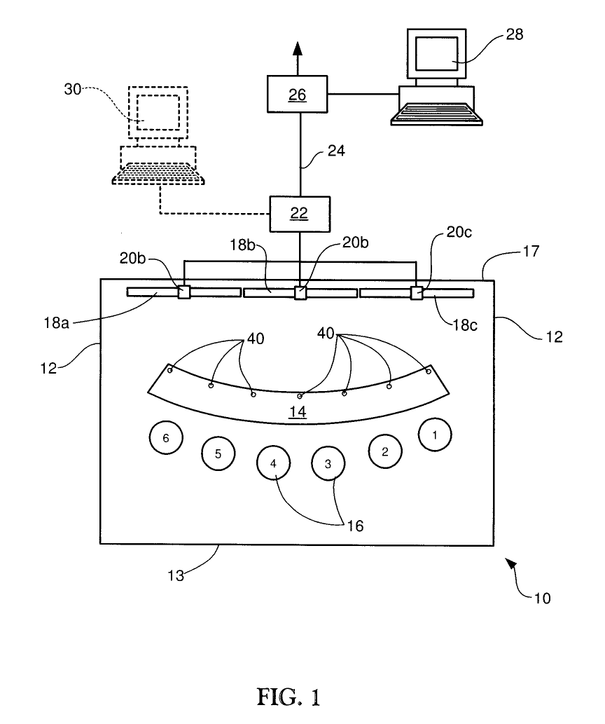

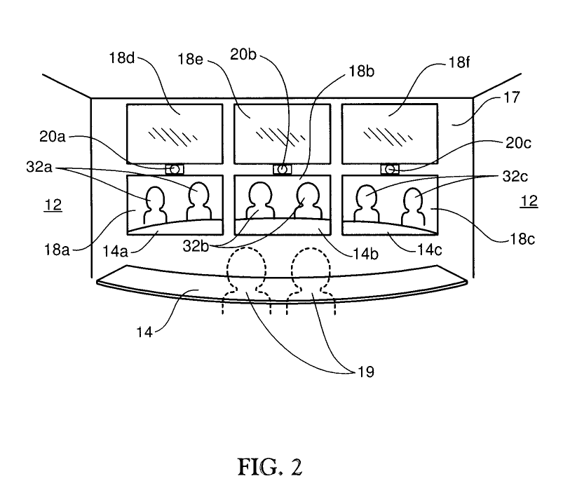

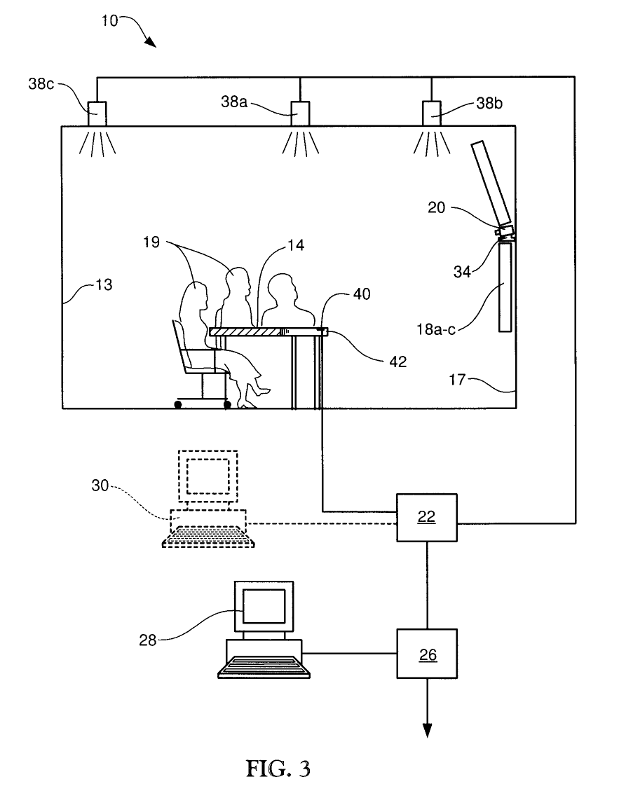

This application relates generally to lighting calibration in a video display environment, such as a specialized video conference environment. Specialized video conference environments that are designed to provide the look and feel of an in-person conference, also called “remote presence” video conference studios, have been developed and are becoming more widely used. A plan view of one embodiment of a specially-configured video conference studio 10 is provided in FIG. 1. A perspective view looking toward the displays at the front of an embodiment of such a room is provided in FIG. 2, and an elevation/cross-sectional view of such a room is shown in FIG. 3.

In the embodiments shown in FIGS. 1-3, the video conference studio 10 is a room bounded by side walls 12, a back wall 13, a front wall 17, and having a conference table 14 with a plurality of participant positions 16 (e.g. chairs, numbered 1-6 in FIG. 1) adjacent to the table, at which video conference participants (19 in FIG. 2) can sit. On the front wall 17 of the room, opposite the conference table, are a plurality of video conference displays 18 (e.g. flat panel or other video displays), with a video camera 20 positioned near each display. In FIG. 1 only three display positions are shown, labeled 18a-c. The view of FIG. 2 shows six displays arranged in vertical pairs, these displays being labeled 18a-f. While three cameras and three display positions are depicted in FIG. 1, and three cameras and six displays are shown in FIG. 2, it is to be understood that video conference systems generally and remote presence video conference systems in particular are not limited to these numbers. Such studios can have more or less than these numbers of cameras and displays. While the cameras are depicted in FIGS. 2 and 3 as being positioned between the respective pairs of monitors or displays, they can be in other locations around the studio, such as above the displays, located above or adjacent to a different part of the display, or located separate from the display, etc.

The cameras 20 and displays 18 are interconnected to a control system 22, such as a computer network, which in turn is interconnected via a communications network (e.g. the Internet), represented by line 24, to one or more remote information systems 26. Video images taken from other video conference studios are transmitted via the computer network system and displayed upon the corresponding displays of the opposing room(s). For a video conference, the remote information system can be a similar video conference control system (not shown) associated with a remote video conference studio (not shown).

The remote information system 26 can also allow a remote user to control or adjust the video conference cameras 20, displays 18 and other components of the video conference room 10. The remote information system can be interconnected to a data entry device, such as a computer terminal 28, through which the video conference system can be controlled and monitored, and through which a user can enter and transmit data within the system. Similar data entry devices can be associated with other portions of the video conference system as well. For example, a data entry terminal 30 (shown in dashed lines in FIG. 1) can be associated with the local control system 22 to allow a user to control and monitor the video conference system.

It is to be understood that the terms “computer,” “controller,” “terminal” and “server” are intended to include any type of computing device, such as a personal computer, portable computer, workstation computer, server, etc. The term “network” is intended to include networks of computing devices, such as a local area network (LAN), the Internet, etc. Computing devices frequently include a processing unit, system memory, and a system bus that couple the processing unit to various other components of the system. The processing unit can include one or more processors, each of which may be in the form of any one of various commercially available processors. Generally, each processor receives instructions and data from a read-only memory and/or a random access memory. The computing device can also have associated with it a hard drive, a floppy drive, CD ROM, or other data access device that is connected to the system bus by respective interfaces. The hard drive, floppy drive, and CD ROM drive can contain respective computer-readable media disks that provide non-volatile or persistent storage for data, data structures and computer-executable instructions. Other computer-readable storage devices (e.g., magnetic tape drives, flash memory devices, and digital versatile disks) can also be used with the system.

Viewing FIG. 2, the video conference studio can include three positions for displays 18, with two displays at each position, disposed one above the other. The lower displays, 18a-c, can be configured as video conference views, showing conference participants 32 in the other studios, while the upper displays 18d-f can be configured as reference displays, which can be used to show illustrations, diagrams, documents, and other reference materials to which the conference participants may refer. This allows participants to face each other to talk, and to view common reference materials provided on the reference displays during the conference without significantly averting their gaze.

Viewing FIG. 3, the video cameras 20 can each include a pan-tilt-roll (PTR) mechanism 34, which allows the orientation and alignment of each camera to be adjusted. Each camera has a field of view that depends on the orientation of the camera (pan, tilt and roll) and the zoom and focus setting of the camera itself. Adjustment of the camera alignment, along with adjustment of the zoom and focus controls of the camera, allows each camera to provide different views, which can be desirable in different circumstances. Viewing FIG. 1, in a six position video conference studio, a common camera orientation can have each of three cameras 20 oriented substantially straight ahead, taking an image of the two participant positions 16 that are directly opposite the associated display 18.

With a video conference studio configured in this way, various views can be provided, one example of which is illustrated in FIG. 2. In a four-way video conference (i.e. four video conference rooms interconnected in a roundtable fashion) using four video conference rooms configured like that of FIG. 1, the field of view of each of the three cameras 20 can be adjusted to view the same group of two participants in a given room, though from different vantage points. That is, referring to FIG. 1, all cameras 20a-c can be adjusted to view participant positions 3 and 4 in each room. Each different view of the participants is provided to only one of the other three video conference studios, so that each studio receives a unique combination of right, left and center views of other participants, to give the appearance for all participants of a face-to face, round table type conference.

Thus, each video conference studio receives straight-on and right and left side angle views, respectively, of the participants in the other conference rooms, corresponding to their display positions. This provides an appearance like that shown in FIG. 2, wherein the center display 18b shows the center two participants 32b from one of the other rooms from straight on. The center display in that other room will likewise show the straight on view of the participants in the room 12. The left hand display 18a shows the two participants 32a from one of the other rooms from a left side view. For a roundtable arrangement, the view from the right side camera 20c will be transmitted to the studio from which the view on the left hand display comes. Finally, the right hand display 18c shows the center two participants 32c from the last room from a right side vantage point, and the view from the left side camera 20a will be transmitted back to that studio. The relative angle and curvature of the visible portion of the conference tables 14a-c from each room suggests the different vantage points. This configuration gives the feeling that the conference table 14 at which the local participants are seated continues around in a circle, with all participants seated at the same round conference table.

It is to be appreciated that the views and images shown herein are exemplary only, and that a wide variety of other fields of view and corresponding images can be provided. Likewise, certain camera orientations and corresponding views may be more desirable or common than others, both among those shown herein and others not shown.

As noted above, changes in lighting in a video conference environment can affect how the conference is perceived. There are a number of lighting changes that can affect a conference. These include reduced light, which can cause participants to appear dark and hard to see. On the other hand, Increased light can cause images to clip, causing features to disappear. Additionally, lighting changes can produce white point shifts, such that participants and objects can appear in odd or disturbing colors (bluish, greenish, etc). Inconsistent lighting can also be a problem, causing some participants to look too dark or too light.

Lighting in a video display environment can be calibrated during initial installation or during follow-up service. However, this generally involves a technician physically present in the video display environment to take lighting measurements and make needed adjustments.

Advantageously, the inventors have developed a lighting calibration system and method that allows lighting parameters to be remotely monitored, and allows many lighting problems to be corrected remotely, without having a technician physically travel to the location. This system and method generally involves the use of low-cost light and color sensors to calibrate, monitor status, and identify changes in environmental lighting. This information can be used to improve the performance of a video display environment and allow remote supportability. This system will help identify problems like reduced light, increased light, white point shifts, and inconsistent lighting, and aid in correcting them via automatic corrections, notifications to support personnel, or a combination of these actions.

The video conference studio 10 shown in FIGS. 1 and 3 illustrates one embodiment of a video display environment having a lighting calibration system as disclosed herein. This video conference studio includes several light fixtures 38, which illuminate the room and the conference table 14. These light fixtures can take a variety of forms, such as recessed can type lights, having incandescent or fluorescent bulbs. Alternatively, the light fixtures can be other types of lighting devices, such as LED light devices. LED lights present several potential benefits, such as lower electricity usage and variable color. Additionally, as semiconductor devices, LED lights can be interconnected to the control system 22, by which the light intensity and color can be controlled. As shown in FIG. 3, the lighting fixtures can include lights 38a positioned substantially above the conference table 14, lights 38b that are positioned near the front wall 17 of the video conference studio, and lights 38c that are positioned near the back wall 13.

In the embodiment of FIGS. 1 and 3, a series of 7 lighting sensors 40 are attached near (e.g. embedded within) the front edge 42 of the video conference table 14 and interconnected to the controller 22. In one embodiment, these sensors are light intensity sensors. This sensor arrangement can be used to detect when any one of the lights in the room burns out. For example, each sensor can be positioned in approximate alignment with a particular light fixture. With multiple sensors placed in the vicinity of multiple light fixtures, it is possible to detect when specific lights burn out or change in intensity. A change in intesity of one light will present a different intensity signal pattern among the group of sensors than will a change in intensity of another light. Using a process similar to triangulation, the presence and identity of a burned out or failing light can be distinguished from a change in the entire environment. It is to be understood that the number of light intensity sensors can vary, and can be more than, less than, or equal to the number of light fixtures in the room.

When a change in light intensity is identified, several actions can be taken. If the change is detected to be in substantially the entire population of lamps, automatic corrections in the iris of the camera 20 can be made. Alternatively, where the light fixtures 38 are electronically controllable (e.g. LED lights), such as the light fixtures 38 that are interconnected to the controller 22 in FIG. 3, the lighting intensity can be automatically adjusted to correct for the change. As a final alternative, if a light is burned out and automatic correction or compensation is not possible, a replacement light can be scheduled to be installed by a technician. Whether the correction for a change in light intensity is automatic or requires the attention of a person, the controller 22 can send a signal to another communication network or network device 26 in the system, and/or to an input terminal 28 or 30 that is associated with the system providing a suitable notification.

While there can be one sensor for each main lighting fixture, other lighting configurations can also be monitored in a similar way. For example, if there are 10 lights and 7 sensors, a similar method can still be followed. The system can detect the position of a failing or burned out light and provide the desired correction or notification.

A number of sensors exist that can be used for this system. Generally speaking, any type of light intensity sensor can be used, and these can be provided with light filters so as to provide a light intensity reading for a particular portion of the light spectrum if desired. For example, silicon photosensors, diffraction grating-based spectrophotometers, and other types of spectrophotometers can be used. Filters that are used to limit sensing to a particular color can include standard color filters, dichroic filters, diffraction gratings, etc. Some sensors, such as silicon photosensors, can be used to detect overall light intensity without respect to color (i.e. without any light filter), while others can employ color filters to provide a crude lighting color signal, similar to how the eye percieves color (e.g. tristimulus sensors), and other sensors can collect the entire visible spectrum of lighting. Tristimulus color sensors typically comprise a calorimeter having three sensors (typically silicon photodiodes) whose spectral responsivities are modified by dyed color filters to approximate the Commission Internationale de I'Eclairage™ (CIE) red, green, and blue color matching functions of the human visual system. The combination of filters with photodetectors allows the colorimeter to determine the intensity and chromaticity of incident white light by measuring the sensor output with a suitable electrical device, such as a current meter. Tristimulus color sensors are commercially available from Hamamatsu™ and TAOS™. Sensors that collect the entire visible spectrum of lighting include the i1 sensor system, available from X-Rite, Inc. of Grand Rapids, Mich. It is to be understood that the above-listed sensors are only examples of lighting sensors that can be used in accordance with the present disclosure. A variety of types of sensors can be used in addition to those indicated above.

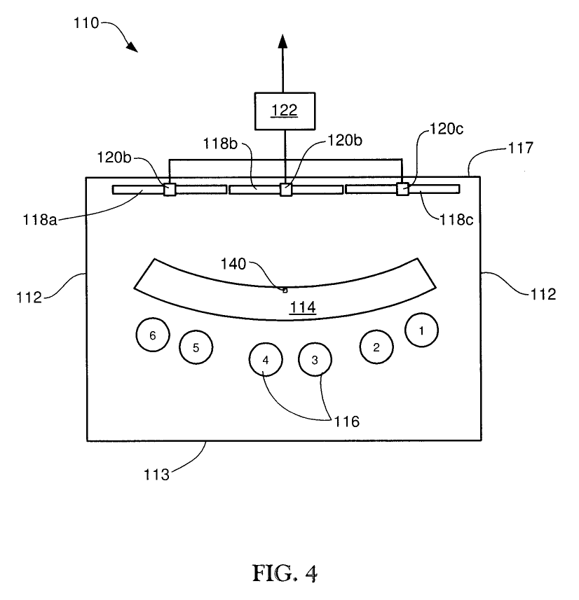

Integrated lighting sensors can be used to detect and compensate for light color changes. A video conference studio 110 that is configured to detect light color changes is illustrated in FIG. 4. Like the studio shown in FIG. 1, this video conference studio provides a room bounded by side walls 112, a back wall 113 and a front wall 117. A conference table 114 having multiple conference participant positions 116 is positioned facing a plurality of displays 118 and cameras 120 that provide conference views to other remote conference rooms via a control system 122.

Positioned near the center of the front edge of the table 114 is a light color sensor 140. While only one sensor is shown, multiple light color sensors could be positioned in the room. Additionally, the location(s) of the one or more sensors can be in various places within the room other than the location shown in FIG. 4. This sensor detects the light color and compares this detected color with a desired color, which can be stored in memory in the controller or elsewhere. The light color sensor 140 and the controller system can be configured to detect a variety of possible causes of light color change. These causes can include aging of the lamps, changes in reflective surfaces (e.g. wall paint or fabric), changing lamps to a lamp having a different color temperature, and the influence of external lighting, such as sunlight.

When a change in lighting color is identified, several changes can be made, both automatic changes and/or changes involving the intervention of a technician or other person. Where the lighting devices in the room are controllable by the controller 122 (e.g. LED light fixtures as discussed above with respect to FIG. 3), the color output of the lights can be varied. For example, if the lighting color becomes too yellow, one or more LED lighting devices can be caused to emit a more bluish light to compensate. If the change is gradual, or similar, the spectral information collected by a sensor could be used to automatically adjust one or more of the white balance, color matrix, and color correction settings of one or more of the cameras 120. This would allow more consistency between cameras in different or changing environments. If the change is the result of a lamp that is a wrong color temperature, service can be notified that the change was wrong and is degrading the experience. The various color changes discussed above can be measured off of a single color sensor 140 (as shown) or multiple color sensors can be used. The ability of the system to detect and correct lighting color changes is likely to be enhanced by the use of multiple color sensors.

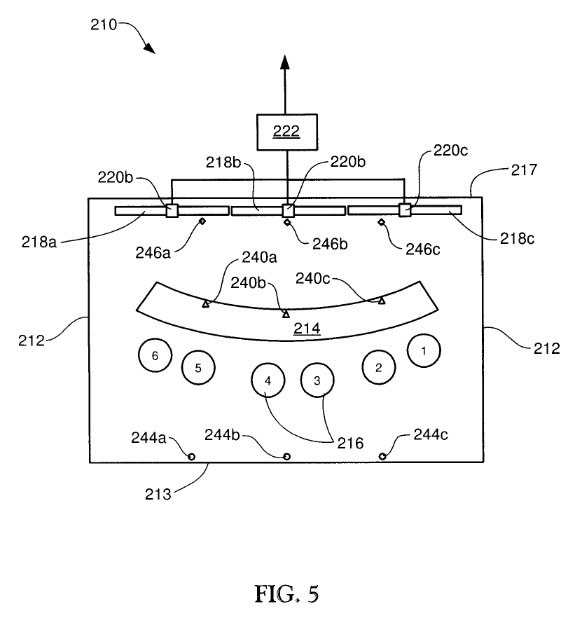

Integrated lighting sensors can also be used to measure ambient light changes. As shown in FIG. 5, a video conference studio 210 that like the studio shown in FIG. 4, can include one or more ambient light sensors 240 positioned along the front edge of the conference table 114. In this embodiment the video conference room includes three ambient light sensors 240a-c, though different number of such sensors can be used. Likewise, a number of locations exist where ambient light changes can be effectively measured. The three sensor locations shown in FIG. 5 are only three examples of such locations.

Using feedback from the ambient light sensors 240, lighting at the conference table 214 can be monitored, and either the lighting or cameras can be adjusted to provide the desired experience. Ambient lighting sensors 244 can also be located at the back wall 213 of the room to facilitate adjustments to backwall lighting, such as for back row participants in a video conference. These sensors can provide information that can be used by the controller 222 for adjustment of lighting near the back wall, such as would be provided by back row lights 38c in FIG. 3.

Similarly, ambient light sensors 246a-c can be placed at or near the front wall 217, and a number of measurements can be taken there. Ambient light at the front wall and near the displays 218 can affect the usability of the displays. If ambient light changes significantly at the front wall, this can be detected and changes can be made in the displays to compensate for this, such as brightness, contrast, and gamma. For example, if ambient light at the front wall increases, the black point of the displays will increase, requiring adjustments in brightness and gamma to cause the image to retain the desired quality. Where lights near the front of the room are controllable by the controller 222 (like front row lights 38b in FIG. 3) the system can automatically adjust the light intensity and/or color for these lights to compensate.

In another embodiment, sensors 246 at the front wall 217 can be provided with a lens to allow them to look toward the back wall 213. These front wall sensors can thus measure lighting at the back wall, and allow the controller 222 to make adjustments to the cameras 220 or lighting so that the back wall will be rendered the same from all video conference locations.

Another aspect of lighting change that can be detected by the use of integrated sensors in a video display environment is flicker and low frequency light changes. Some lighting devices, such as fluorescent lights, are subject to flicker, which is not necessarily detectable by a video camera 220 or noticeable to a person viewing the room remotely, but which can be very annoying to a person in the video conference environment. To detect and compensate for these issues, higher speed light sensors can be used, both for light intensity and ambient light sensors, to identify these problems and report them to service personnel to prompt repairs.

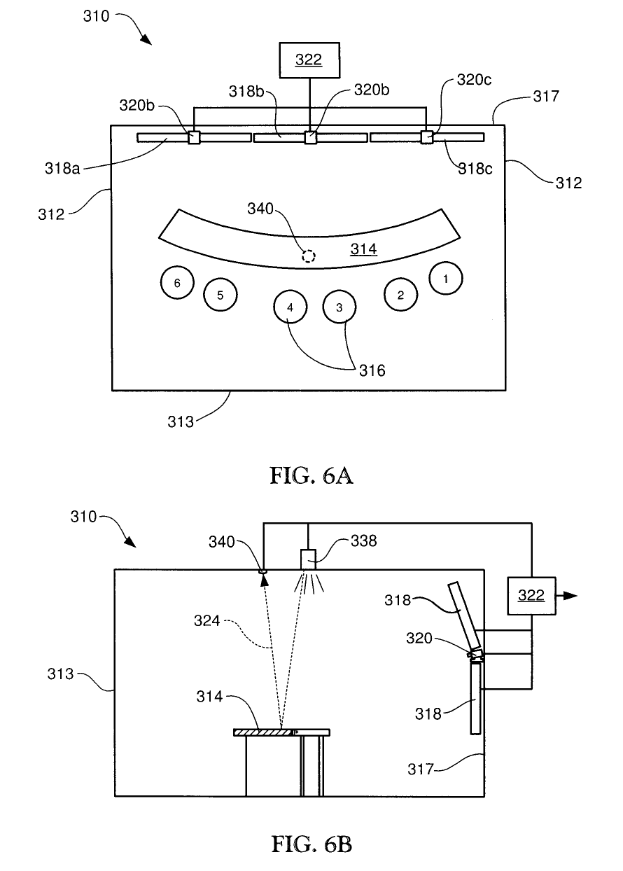

There are other ways in which an array of integrated lighting sensors can be used for calibrating lighting in a video display environment, such as a remote presence video conference studio. One such example is shown in FIGS. 6A and 6B. Like the other embodiment discussed above, this video conference room 310 has sidewalls 312, a back wall 313, and a front wall 317 that includes one or more displays 318 and cameras 320. A conference table 314 is positioned in the room and includes multiple positions 316 for video conference participants. The displays and cameras are interconnected to a local controller 322 that allows video images to be sent to and received from remote video conference rooms.

This video conference room 316 includes a single photospectrometer 340 mounted on the ceiling of the room above the conference table 314. In this embodiment, the spectral reflectivity of the surface of the conference table can be measured (e.g. at the time of manufacture) and a spectral reflectivity value for the table can be recorded, such as being stored in memory in the local controller 322. After the table is installed in the room, reflected light, represented by dashed line 324, such as from a lighting fixture 338 can be detected by the ceiling-mounted photospectrometer, allowing the control system 322 to calculate the spectral distribution of the actual light source. The system can then use this information to correct for ambient light conditions in the manner discussed above. For example, where the lighting fixtures 338 are adjustable in color, intensity, etc., the system can automatically adjust the lighting. Other changes, both automatic and manual, can be made as discussed above.

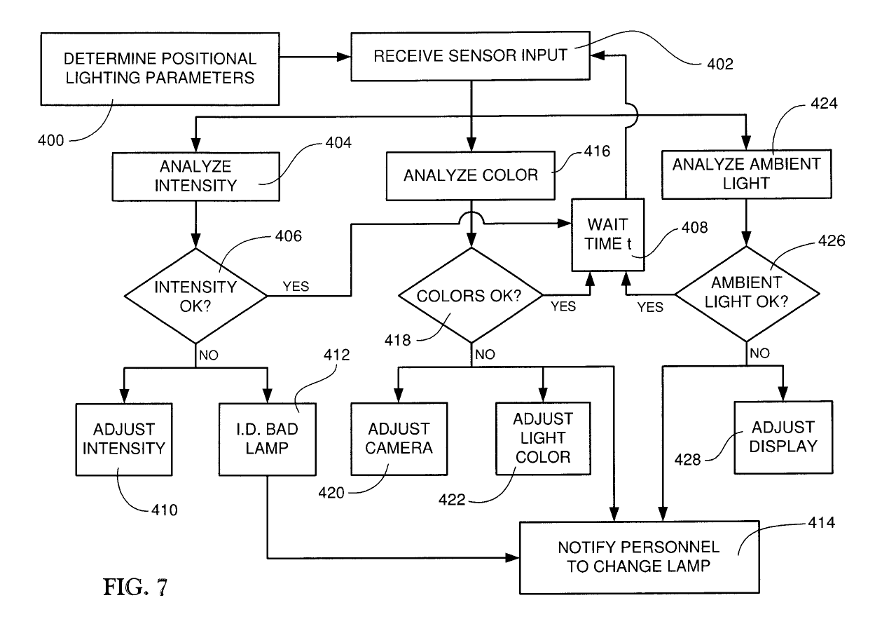

Some of the light sensing and lighting calibration processes discussed above are outlined in a flow chart provided in FIG. 7. The steps outlined in this flow chart can be performed by a local controller (22 in FIG. 3) or a remote controller (26 in FIG. 3), and can be done either automatically by the control system, or under manual control by a person, or a combination. It will be apparent that some steps outlined in FIG. 7 are to be done by a person.

Before receiving sensor input regarding the lighting conditions in a video display environment, the positional lighting parameters are determined (step 400) and stored for comparison. These positional lighting parameters represent a lighting standard that is selected for the video display environment. The system then receives sensor input from the various lighting sensors (step 402) and moves on to any of several analysis steps in which actual lighting conditions are compared to the selected lighting standard.

One analysis step is to analyze the lighting intensity (step 404). As discussed above, with multiple light intensity sensors in a video conference room, the sensors give positionally unique signals indicating the lighting intensity. These signals indicate the magnitude and position of lighting intensity variations from the lighting standard, or, on the other hand, these signals can indicate that the lighting intensity is within an acceptable range throughout the video display environment. If the lighting intensity is within acceptable parameters, as determined at step 406, the system can wait some preprogrammed time interval t (step 408), then return to step 402 to receive the next sensor input.

If lighting intensity as determined at step 406 is not within acceptable parameters, one of several steps can be taken. If the video display environment includes remotely adjustable lighting devices (e.g. LED lights, incandescent lights with a dimmer circuit) that can be adjusted in output intensity, the system can automatically adjust the intensity of any given lighting device (step 410). Alternatively, if the lights are not adjustable or cannot be remotely adjusted in intensity, the system can identify a lamp that needs to be replaced (step 412) and notify maintenance personnel to change the lamp (step 414). After lighting changes are made or the appropriate changes are indicated to maintenance personnel, the system can return to step 402 to receive sensory feedback to determine whether the changes have been effective, or whether additional or different changes are needed.

Though not shown, the system can also save lighting intensity sensor output values in memory, along with a time indicator, so that these values can be used to determine a time-based variation in lighting conditions. By performing the detection and analysis steps repeatedly over time and saving the results in memory, the positionally unique signals that the system receives each time from the lighting sensors become temporally unique signals. Since multiple sensors give positional light intensity information, the system thus provides positionally and temporally unique signals. The variation of these signals over time provides an indication of when lighting conditions in the display environment differ from the selected lighting standard, and also of how rapidly the variation takes place. Rapid changes can be interpreted to indicate sudden changes in lighting devices (e.g. burned out bulbs), which can indicate the need for a person to visit the site to install new bulbs. More gradual changes, such as in light intensity and color, can indicate gradual degradation of lighting devices, and can indicate that various remote and/or automatic changes may be effective to address the lighting changes, as discussed above. The control system can thus be programmed to determine which lights need adjustment or replacement at any given time, and can also recognize trends in particular lights, allowing the system to predict when a given light is likely to need to be adjusted or replaced.

After receiving sensor input (step 402) another analysis step is to analyze lighting color (step 416). If lighting color is within acceptable parameters, as determined at step 418, the system can wait a time interval t (step 408), then return to step 402. However, if lighting color is not acceptable, the system can take one of several subsequent steps. In one embodiment, the system can remotely adjust one or more cameras in the room (step 420) to compensate for the lighting color, as discussed above. Alternatively, if the video display environment includes color adjustable lighting devices (e.g. RGB LED lights), the system can remotely automatically adjust the light color of any given lighting device (step 422) to provide the proper light color. As another option, where these other alternatives are not available or effective, or without regard to them, the system can notify maintenance personnel to change one or more lamps (step 414) to provide the desired lighting color.

The positionally unique signals from the sensors allow the system to determine exactly which camera or lighting device to adjust or replace. Also, the system can record positional and time-based changes in lighting color to obtain unique time and position based lighting information for color, in the same manner as with light intensity, as discussed above. Once again, after lighting changes are made or the appropriate changes are indicated to maintenance personnel, the system can return to step 402 to receive sensory feedback to determine whether the changes have been effective, or whether additional or different changes are needed, and to proceed to other analysis steps.

An additional lighting sensing and calibration aspect is the detection and correction for ambient light changes. Upon receiving sensor input (step 402) the system can analyze ambient light conditions (step 424). If ambient light is considered satisfactory, as determined at step 426, the system can wait some time interval t (step 408), before returning to step 402. If ambient lighting is not within the selected standards, the system can automatically adjust one or more video displays (step 428) to compensate, or it can notify the appropriate personnel to make the required adjustments (step 414). Once again, the positionally unique signals from the sensors allow the system to determine exactly which display or lighting device to adjust or replace. Also, the system can record positional and time-based changes in ambient light to obtain unique time and position based lighting information, in the same manner as with light intensity and color, as discussed above. Once again, after display changes are made or the appropriate changes are indicated to maintenance personnel, the system can return to step 402 to receive sensory feedback to determine whether the changes have been effective, or whether additional or different changes are needed, or to return to other analysis steps.

The system and method disclosed herein thus provides a system and method for detecting and calibrating lighting in a video display environment using sensors that are integrated into the environment. The system provides a video display environment having a video display, fixedly positioned in the environment and at least one lighting sensor, fixedly positioned in the environment near the display. A lighting detection system is coupled to the lighting sensor, and is controllable from outside the environment to determine positionally and temporally unique lighting information, to provide an indication when lighting conditions in the environment differ from a selected lighting standard. The system and method thus helps improve the supportability and adaptability of video display environments, such as remote presence video conference studios.

It is to be understood that the above-referenced arrangements are illustrative of the application of the principles disclosed herein. It will be apparent to those of ordinary skill in the art that numerous modifications can be made without departing from the principles and concepts of this disclosure, as set forth in the claims.

What is claimed is:

1. A lighting calibration system for a video display environment, comprising:
a video display, fixedly positioned in a video display environment;
a lighting sensor, fixedly positioned in the environment; and
a lighting detection system, coupled to the lighting sensor and controllable from outside the environment, configured to receive positionally and temporally unique signals from the lighting sensor, and to provide an indication when lighting conditions in the environment differ from a selected lighting standard, based upon the signals.

2. A video display environment in accordance with claim 1, wherein the lighting sensor comprises a color sensor, configured to indicate a change in light color in the environment.

3. A video display environment in accordance with claim 1, further comprising a fixed table within the environment, the lighting sensor being attached to the table.

4. A video display environment in accordance with claim 3, wherein the lighting sensor comprises a plurality of lighting sensors, the positions of the sensors being approximately aligned with positions of lighting fixtures in the environment.

5. A video display environment in accordance with claim 1, wherein the sensor is positioned to detect light reflected from a surface of known reflective properties within the environment.

6. A video display environment in accordance with claim 1, wherein the lighting sensor comprises a plurality of lighting sensors, each having a unique fixed position in the environment, a change in a lighting signal pattern from the plurality of sensors being indicative of a position in the environment experiencing a change in lighting conditions.

7. A video display environment in accordance with claim 6, wherein the sensors are selected from the group consisting of light intensity sensors and light color sensors.

8. A video display environment in accordance with claim 6, wherein the sensors are located in at least one position selected from the group consisting of adjacent to the video display, opposite the video display, and attached to a fixed table within the environment.

9. A video display environment in accordance with claim 1, further comprising lighting elements, disposed in the environment and interconnected to the lighting detection system, at least one of light intensity and color of the lighting elements being selectively adjustable via the lighting detection system in response to the positionally and temporally unique signals from the lighting sensor.

10. A method for calibrating lighting in a video display environment, comprising the steps of:
a) affixing a lighting sensor within the video display environment;
b) obtaining light signals from the sensor;
c) analyzing the light signals to determine a positionally and temporally unique lighting condition; and
d) adjusting devices in the environment to conform to a pre-selected lighting standard.

11. A method in accordance with claim 10, further comprising periodically repeating steps (b) through (d).

12. A method in accordance with claim 10, wherein the step of affixing a lighting sensor within the video display environment comprises affixing multiple sensors at fixed locations in the environment, the sensors being selected from the group consisting of light intensity sensors and light color sensors.

13. A method in accordance with claim 10, wherein the step of adjusting devices in the environment comprises adjusting, via a control system controllable from outside the environment, at least one of: an intensity of a lighting fixture in the environment, a light color of a lighting fixture in the environment, sensing characteristics of a camera in the environment, and display characteristics of a video display in the environment.

14. A method in accordance with claim 10, wherein the step of adjusting devices in the environment comprises a person entering the environment to adjust or replace lighting elements therein.

15. A method in accordance with claim 10, wherein the step of analyzing the light signals comprises analyzing a reflectance signal representing reflectance of light from a surface of known reflective characteristics, and comparing the reflectance signal to a baseline reflectance signal to determine at least one of ambient light intensity and color in the environment.

16. A computer program product comprising machine readable program code for causing a computing device associated with a video display environment to perform the steps of:
a) obtaining signals from a lighting sensor at a fixed location within the video display environment;
b) analyzing the signals to determine a positionally and temporally unique lighting condition;
c) comparing the positionally and temporally unique lighting condition to a pre-selected lighting standard; and
d) adjusting devices in the environment to substantially conform to the pre-selected lighting standard.

17. A program product in accordance with claim 16, wherein the step of obtaining signals from a lighting sensor at a fixed location within the video display environment comprises obtaining signals from a plurality of lighting sensors located at fixed locations within the environment.

18. A program product in accordance with claim 16, wherein the step of obtaining signals from a lighting sensor at a fixed location within the video display environment comprises obtaining a signal representing at least one of light intensity and light color.

19. A program product in accordance with claim 16, wherein the step of adjusting devices in the environment comprises remotely adjusting at least one of: an intensity of a lighting fixture in the environment, a light color of a lighting fixture in the environment, sensing characteristics of a camera in the environment, and display characteristics of a video display in the environment.

20. A program product in accordance with claim 16, wherein the step of adjusting devices in the environment to substantially conform to the pre-selected lighting standard comprises electronically sending a notice prompting a person to enter the environment to adjust or replace lighting elements therein.
